(19) United States
(12) Patent Application Publication
(10) Pub. No.: US 2010/0308077 A1
(43) Pub. Date: Dec. 9, 2010

(54) DISPENSING DEVICE

(75) Inventor: Dietmar Sonntag, Laupheim (DE)

Correspondence Address: Jason H. Vick;Sheridan Ross, PC, Suite # 1200, 1560 Broadway, Denver, CO, 80202, US

(73) Assignee: SEAQUIST PERFECT DISPENSING GMBH, Dortmund (DE)

(21) Appl. No.: 12/675,204

(22) PCT Filed: Aug. 25, 2008
(86) PCT No.: PCT/EP2008/006958

§ 371 Date: Apr. 29, 2010

(30) Foreign Application Priority Data
Aug. 29, 2007 (DE) 102007040998.4
Oct. 31, 2007 (DE) 102007051980.1

(51) Int. Cl. B67D 7/84

(52) U.S. Cl. 222/95; 222/105; 222/402.1

(57) ABSTRACT

Proposed is a dispensing device for a cosmetic product. A flexible inner container is ultrasonically welded with a valve housing. The valve housing is provided with a welding bead which is covered by the inner container during welding. The inner container is welded with the valve housing for a housing length of at least 70% and extends particularly up to a plate which holds the valve housing in an outer container.

The present invention relates to a dispensing device for a preferably cosmetic product according to the preamble of one of the independent claims.

The dispensing device is preferably used for the non-spraying delivery or dispensing of a preferably cosmetic product. However, spraying delivery can also be provided.

The term “cosmetic product” is to be understood, in a narrower sense, as cosmetics, hair spray, hair lacquer, a deodorant, a foam, particularly shaving foam, a gel, a color spray, a sun protection or skin care agent or the like or other cosmetic liquids, fluids, pastes, lotions, emulsions or the like. Preferably, however, in a broader sense, other body care products, cleaning products or the like, and even suspensions and fluids, particularly those with gas phases, are included as well. Moreover, other liquids, for example air improvers and particularly technical liquids and fluids as well such as antiseizes and the like, can also be used. Nonetheless, for the sake of simplicity and due to the emphasized use, there is often only mention of cosmetic product in the following. Especially preferably, the proposed dispensing device is used for the storage and delivery of a gel, particularly shaving gel, or a paste, particularly toothpaste, or the like.

EP 0 320 510 B1 discloses a dispensing device with a valve which has a valve housing. The valve housing is provided with a tubular section with side wings extending radially on opposing sides. A baglike, flexible inner container is welded to the side wings and the tubular section by means of thermal welding. The valve is held by a plate which is joined with the outer container in a gas-tight manner. Pressure is exerted on the inner container by gas in the outer container in order to enable the delivery of a cosmetic product contained in the inner container. To facilitate good thermal welding, the valve housing and the inner wall of the inner container are preferably manufactured from polypropylene. The diffusion behavior poses a problem. In particular, polypropylene is not diffusion-tight, particularly with respect to oxygen. Accordingly, long-term storage can be problematic, since oxygen can diffuse into a valve space through the valve housing and lead to undesirable reactions, particularly in the case of a cosmetic product. To counteract this undesirable effect, it is necessary to design the valve housing with very thick walls. This is disadvantageous, however, with regard to material costs and construction size.

It is the object of the present invention to provide an improved dispensing device which enables simplified and/or more cost-effective manufacture with respect to the prior art and/or which can be used universally, particularly with other materials as well.

The above object is achieved through a dispensing device according to one of the independent claims. Advantageous modifications are the subject of the subclaims.

According to a first aspect of the present invention, the inner container is ultrasonically welded with the valve housing. Moreover, polyethylene or polyamide is preferably used for the valve housing and the inner layer of the inner container. In this way, simplified and cost-effective manufacture is made possible; particularly, the valve housing can be designed such that it is thinner with equally good or even better diffusion tightness.

According to a second aspect of the present invention that can also be implemented independently, at least one welding bead is arranged or formed on the valve housing prior to welding, which is covered during welding by the inner container. This, again, is conducive to simple and cost-effective manufacture, particularly to the welding of the inner container with the valve housing by means of ultrasound.

According to a third aspect of the present invention that can also be implemented independently, the inner container is welded with the valve housing over a length of at least 70% or more of the longitudinal extension of the valve housing. Alternatively or in addition, the inner container is welded or connected with the valve housing up to a side of a plate of the valve facing or adjoining the inner container which connects the valve housing with an associated outer container. This is conducive to increasing the diffusion tightness and permits, in particular, a smaller wall thickness of the valve housing with sufficient or even improved diffusion tightness and hence simpler and more cost-effect manufacture.

Further advantages, features, characteristics and aspects of the present invention follow from the claims and the following description of a preferred embodiment on the basis of the drawing.

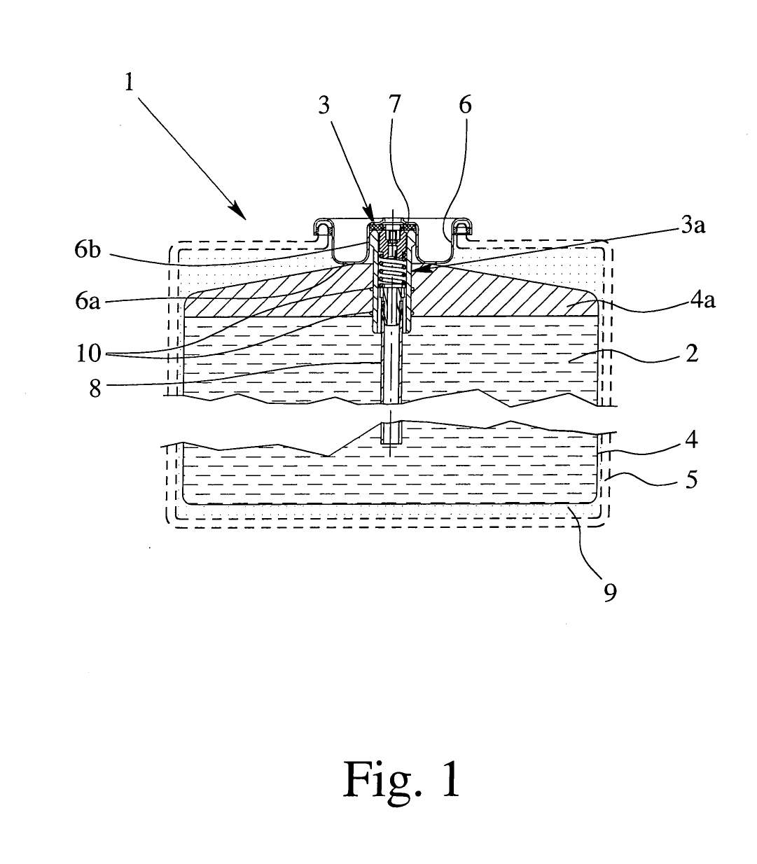

FIG. 1 shows a schematic section of a proposed dispensing device;

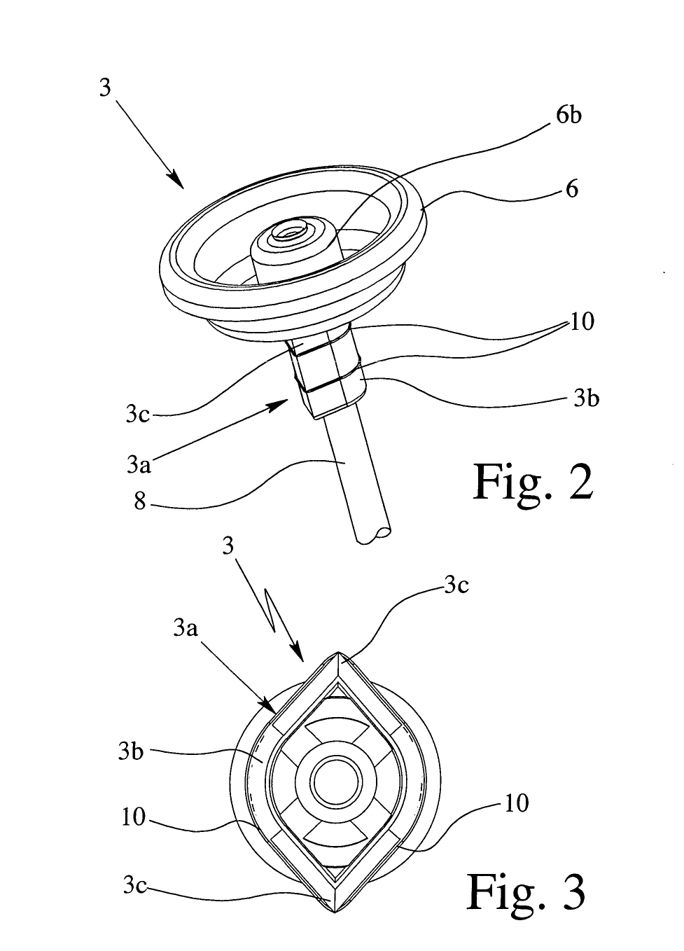

FIG. 2 shows a schematic perspective view of a valve of the dispensing device;

FIG. 3 shows a view of the valve from below.

In the not wholly true-to-scale, only schematic figures, the same reference symbols are used for same or similar parts, with corresponding or comparable characteristics and advantages being achieved even if a repeated description is omitted.

In a schematic view, FIG. 1 shows a proposed dispensing device 1 for dispensing a preferably cosmetic product 2 in the sense named at the outset. The product 2 is particularly a shaving gel, toothpaste, or the like.

The dispensing device 1 has a valve 3 through which the product 2 can be delivered. As needed, the valve 3 can be embodied as a dosing valve or the like. It can be opened, for example, by depressing a delivery head (not shown) connected thereto or in another appropriate manner. In particular, the product 2 can be delivered via the valve 3 or a delivery head or the like in liquid form or pasty form, as foam, as gel or the like.

The dispensing device 1 has a flexible inner container 4 as indicated schematically in FIG. 1. The inner container 4 is particularly embodied as a bag. Preferably, it is a folded container or bag that is welded closed. However, other constructive solutions are also possible.

Especially preferably, the wall of the inner container 4 is film-like and/or formed by a composite film. The wall is preferably embodied such that it is diffusion-tight, at least to a large extent. For example, the wall or film can have an aluminum layer, aluminum deposition or the like as well as other layers, particularly consisting of a polyolefin.

The dispensing device 1 also preferably has an outer container 5 which is indicated merely with a broken line in FIG. 1. The inner container 4 is preferably accommodated together with the valve 3 in the outer container 5. In the depicted example, the valve 3 is provided with a plate 6 or held by same which, in turn, is connected with the outer container 5 particularly in a gas-tight manner. Especially preferably, the plate 6 forms a tight-sealing lid or closure of the outer container 5.

The plate 6 is preferably made of metal. In principle, however, it can also be composed of plastic or any other suitable material, particularly a composite material.

The valve 3 has a valve housing 3a which is connected with the plate 6 or held by same. In the depicted example, the plate 6 has a side 6a—here an underside, inner side, flat side or an annular area—facing the inner container 4 or interior of the outer container 5 which is provided with a preferably centered, outwardly protruding recess 6b.

The valve 3 or valve housing 3a is accommodated or held with one end in the recess 6b, particularly in a clamping, nonpositive or positive manner, for example by injection or spraying, caulking, welding, gluing or the like. The valve 3 or valve housing 3a preferably ends on the outlet side in the recess 6b. Preferably, a particularly ring-shaped seal 7 is arranged between the floor of the recess 6b and the front side of the valve housing 3a in order to seal off the outside of the valve housing 5 with respect to the plate 6 and thus seal the outer container 5 in a gas-tight manner. However, other constructive solutions are also possible.

The inner container 4 is connected in a gas-tight manner with the valve housing 3—particularly on the end region or inlet end facing away from the plate 6. This end region or this inlet end protrudes particularly into the inside of the outer container 5 and particularly into the interior of the internal container 4.

The inner container 4 contains the preferably cosmetic product 2 to be delivered. To facilitate the removal of the product 2 from the inner container 4, an optional riser tube 8, particularly a hose or the like, can be connected on the inlet side to the valve 3. The riser tube 8 is particularly inserted into a connector on the inlet side formed by the valve housing 3a, or is or can be connected on the inlet side in another suitable manner with the valve housing 3a.

The outer container 5 is filled with a pressurized gas 9 which is indicated with dots in FIG. 1. The gas 9 is particularly air or another suitable pressurized gas, optionally even liquefied gas or the like.

The gas pressure in the outer container 5 acts on the outside of the flexible inner container 4 so that, when the valve 3 is open, the product 2 is output via the valve 3 and an optionally adjacent delivery head or the like. When the product 2 is removed or dispensed, the inner container 4 collapses.

As already mentioned, the inner container 4 is preferably connected in a gas-tight manner, particularly welded, with the valve housing 3a. Especially preferably, the inner container 4 is ultrasonically welded with the valve housing 3a. This enables a substantially more energy-saving, quicker and/or more cost-effective manufacture of the dispensing device 1 compared to the thermal welding provided in the prior art. It is also possible in principle, however, to connect the inner container 4 with the valve housing 3 in another suitable manner, for example through another type of welding, clamping, spraying, gluing or the like.

In the depicted example, the valve 3 or valve housing 3a has an at least substantially tubular section 3b and, particularly, two side wings 3c arranged on opposing sides of the section 3b and particularly extending radially and along the tubular section 3b. This can be seen particularly in the perspective view of the valve 3 according to FIG. 2 and the bottom view of the valve 3 without plate 6 according to FIG. 3.

The side wings 3c taper preferably toward their free edges. In particular, the two wings 3c come to a point toward the outside or radially. This prevents or minimizes gap formation in the region of the free edges and the inner container walls meeting the edge starting from the tubular region 3b.

The inner container 4 is connected, particularly ultrasonically welded, with the valve housing 3a particularly in the region of the preferably tubular section 3b and the side wings 3c. In the depicted example, the inner container 4 preferably has an upper connection seam or weld seam 4a, or one arranged in the region of the valve 3, which seam 4a is indicated in FIG. 1 by hatching and which extends, for example, over the entire width of the inner container 4. Preferably, the valve housing 3a is welded with the tubular section 3b and the side wings 3c into this weld seam 4a. However, other constructive solutions are also possible.

To render the valve housing 3a as diffusion-tight as possible, which is to say to minimize a possible diffusion of the gas 9 or components of the gas 9 such as oxygen through the valve housing 3a into a valve space with the product 2 where the gas 9 or a component thereof is able to react with the product 2, particularly in the event of long-term storage, the inner container 4 is connected or welded with the valve housing 3a preferably over a length of at least 70%, particularly about 80% or more, of the longitudinal extension of the valve housing 3a or valve 3, thus covering the valve housing 3a in a diffusion-tight manner.

Alternatively or in addition, the inner container 4 is connected or welded with the valve housing 3a preferably up to the side 6a of the plate 6 facing the inner container 4 or adjacent thereto in order to increase the diffusion-tightness of the valve housing 3a.

By virtue of the increase in diffusion-tightness, it is possible in principle to reduce the wall thickness of the valve housing 3a. This enables a more cost-effective manufacture.

According to another, likewise independent aspect of the present invention, at least one welding bead 10 is preferably arranged or formed, particularly molded, on the valve housing 3a prior to welding with the inner container 4. The welding bead 10 is covered by the inner container 4 during welding. The welding bead 10 is particularly bar- or rib-like and/or continuous or uninterrupted. In cross section, the welding bead 10 is, for example, substantially triangular, square, rectangular, trapezoidal or convex or arched.

Especially preferably, the inner container 4 is welded with the valve housing 3a along the welding bead 10, so that a defined, at least substantially linear connection is made possible between the valve housing 3a on the one hand and the inner container 4 on the other hand. In this way, a defined and tight connection between the valve housing 3a and the inner container 4 can be achieved with relatively little ultrasonic energy. However, the welding bead 10 can be used not only during ultrasonic welding but during other types of welding as well.

The welding bead 10 preferably has a height and/or width of at least 0.2 mm and/or of at most 0.8 mm, especially preferably of less than 0.5 mm. Very especially preferably, the height and/or width is effectively 0.3 mm.

Especially preferably, the welding bead 10 ends in an edge or tip which is at least substantially rectangular. In cross section, the welding bead 10 is particularly substantially triangular or trapezoidal or provided toward the free end with an at least substantially triangular or trapezoidal tip.

Especially preferably, the welding bead 10 extends at least substantially around a periphery of the valve housing 3a or a surface of the valve housing 3a to be connected with the inner container 4.

Especially preferably, the welding beads 10 extend up to the free longitudinal edges of the side wings 3c, optionally even beyond these somewhat laterally, in order to ensure a good seal and connection with the inner container 4 after welding in the region of these edges as well.

Especially preferably, the welding bead 10 forms a closed loop. However, it can also be merely a finite bar, rib or the like which does not form a closed loop.

Instead of the continuous welding bead 10, several sections which overlap each other, for example, and/or are spaced very close together can also be provided.

Especially preferably, at least two welding beads 10 are provided which are spaced apart or run parallel to each other. In this way, a kind of “double seal” or two-fold linear connection can be achieved between the valve housing 3a on the one hand and the inner container 4 on the other hand.

During the welding of the inner container 4 with the valve housing 3a, a fusing of the welding bead 10 or welding beads 10 occurs and, accordingly, a flattening and connection occurs with the inner container 4.

The welding beads 10 are shown in FIG. 1 only for the sake of clarity. The welding beads 10 are in fact at least substantially no longer present or visible when the inner container 4 is welded on.

Especially preferably, the valve housing 3a and at least the inner layer of the inner container 4 are made of the same material. This facilitates the connection, particularly welding. However, this is not absolutely necessary. It is also possible for different materials to be used which can be connected to one another, particularly through welding or in another suitable manner, as already described.

If the inner container 4 is made of a single-layer material, this material also forms the inner layer. The term “inner layer” is therefore to be understood such that it includes a single-layer construction.

In the depicted example, the valve housing 3a and/or the inner layer of the inner container 4 is preferably composed of polyethylene. This material has a substantially higher level of diffusion-tightness compared to the polypropylene used in the prior art. Moreover, this material can also be welded by ultrasound.

Alternatively, polyamide in particular can also be used for the valve housing 3a and/or the inner layer of the inner container 4. This results particularly in advantages commensurate with those obtained during the use of polyethylene.

It should be noted that the valve housing 3a need not be composed in its entirety of the named material. Rather, according to a modified embodiment not shown, regions of the valve housing 3a can also be made of another material. For example, according to a modified embodiment not shown, it is possible to manufacture the valve housing 3a, in the region in which it is not connected with the inner container 4 or covered by same, from another material and/or to provide it with a covering made of another material, with the other material particularly having a higher level of diffusion-tightness or other advantageous characteristics. For example, it is possible to spray a diffusion-tight covering into these other regions, especially preferably by means of so-called “bi-injection,” which is to say injection of the other material in the same injection mold against a first material.

Individual features and constructive solutions of the described embodiments can also be combined with each other as desired and/or used in other dispensing devices.

### LIST OF REFERENCE SYMBOLS

1 dispensing device
2 product
3 valve
3a valve housing
3b tubular section
3c side wing
4 inner container
4a weld seam
5 outer container
6 plate
6a side (underside plate)
6b recess
7 seal
8 riser tube
9 gas
10 welding bead

1. Dispensing device for dispensing a preferably cosmetic product, with a valve which has a valve housing, and with a flexible inner container which is welded with the valve housing,
wherein
the inner container is ultrasonically welded with the valve housing.

2. Dispensing device for dispensing a preferably cosmetic product, with a valve which has a valve housing, and with a flexible inner container which is ultrasonically welded with the valve housing,
wherein
at least one welding bead is arranged or formed on the valve housing prior to welding with the inner container, which is covered by the inner container during welding.

3. Dispensing device as set forth in claim 2, wherein the welding bead extends at least substantially around a periphery of the valve housing and/or is molded on the valve housing.

4. Dispensing device as set forth in claim 2, wherein two welding beads are provided which are spaced apart and/or run parallel to each other.

5. Dispensing device for dispensing a cosmetic product, with a valve which has an elongate valve housing, and with a flexible inner container which is welded or connected with the valve housing,
wherein
the inner container is welded or connected with the valve housing over a length of at least 70%, particularly 80% or more, of the longitudinal extension of the valve housing.

6. Dispensing device for dispensing a cosmetic product, with a valve which has a valve housing and a plate extending transversely and mounted on the outside of the valve housing for attaching the valve and/or for connecting the valve with an outer container, and with a flexible inner container which is welded or connected with the valve housing,
wherein
the inner container is welded or connected with the valve housing up to a side of the plate facing the inner container or adjacent thereto.

7. Dispensing device as set forth in claim 1, wherein the valve housing and/or an inner layer of the inner container is composed of polyethylene.

8. Dispensing device as set forth in claim 1, wherein the valve housing and/or an inner layer of the inner container is composed of polyamide.

9. Dispensing device as set forth in claim 1, wherein the valve housing has an at least substantially tubular section with which the inner container is welded.

10. Dispensing device as set forth in claim 1 wherein the valve housing has two side wings which protrude at least substantially in a radial manner and/or taper toward their free end on opposing sides of an at least substantially tubular section, with the inner container being welded with the side wings and the section.

11. Dispensing device as set forth in claim 1, wherein the inner container is embodied as a bag.

12. Dispensing device as set forth in claim 1, wherein the inner container collapses upon removal of the product.

13. Dispensing device as set forth in claim 1, wherein the dispensing device has an outer container with which the valve housing is connected in a gas-tight manner or is integrated into the valve.

14. Dispensing device as set forth in claim 1, wherein the inner container is arranged in the outer container and is under external pressure or gas pressure.

15. (canceled)

16. Dispensing device as set forth in claim 2, wherein the welding bead has at least one of a height of at most 0.8 mm and a width of at most 0.8 mm.

17. Dispensing device as set forth in claim 2, wherein the valve housing has an at least substantially tubular section with which the inner container is welded.

18. Dispensing device as set forth in claim 2, wherein the valve housing has two side wings which protrude at least substantially in a radial manner and/or taper toward their free end on opposing sides of an at least substantially tubular section, with the inner container being welded with the side wings and the tubular section.

19. Dispensing device as set forth in claim 2, wherein the inner container is embodied as a bag.

20. Dispensing device as set forth in claim 2, wherein the dispensing device has an outer container with which the valve housing is connected in a gas-tight manner or is integrated into the valve.

21. Dispensing device as set forth in claim 2, wherein the inner container is arranged in the outer container and is under external pressure or gas pressure.
